(19) United States
(12) Patent Application Publication
(10) Pub. No.: US 2020/0107569 A1
(43) Pub. Date: Apr. 9, 2020

(54) Nutritional Composition of Blended Vegetarian Proteins

(71) Applicant: Xiaonan Wen, Allen, TX (US)

(72) Inventor: Xiaonan Wen, Allen, TX (US)

(21) Appl. No.: 16/153,671

(22) Filed: Oct. 5, 2018

(51) Int. Cl. A23L 33/185; A23L 2/66

(52) U.S. Cl. CPC A23L 33/185; A23V 2002/00; A23L 2/66

(57) ABSTRACT

The invention is an improved hypoallergenic nutritional composition consisting of fava protein, mung bean protein, rice protein, and pea protein which are blended in specified weight ratios, to achieve a high level of digestibility comparable to animal proteins such as whey protein, casein protein and egg protein. The problems of potentially allergenic soy protein compositions, solely animal-based protein compositions, incomplete amino acid profile compositions, and low levels of digestibility compositions are solved by inventing a hypoallergenic, vegetarian-based protein composition that can serve as a complete and well-balanced source of amino acids for human physiological requirements and has a high level of digestibility.

### TECHNICAL FIELD

The present invention generally relates to a food or dietary supplement product that includes a blend of plant-based proteins with a high level of digestibility.

### BACKGROUND OF THE INVENTION

Plants constitute a primary resource of carbohydrates, proteins, vitamins, minerals, essential fatty acids, and energy for human food production. It was estimated that plant protein foods contribute 65% of the per capita supply of protein on a worldwide basis and 32% in the North American region.

A plant-based diet is one that is based more on plant sources like fruits, vegetables, and whole grains, rather than on animal sources such as meat and dairy. In recent years, plant-based diet has gained more public popularity. In part because a plant-based diet is naturally free of cholesterol, low in saturated fat, high in fiber, and lower in sodium and added sugar than ones that include animal foods and processed foods. On the other hand, plant-based diet is considered as more sustainable due to fact that livestock production involves a potential loss of the energy and available protein of plants that could otherwise be used to meet human needs.

A most recent cohort study by Mingyang et al. revealed that high intake of animal protein was positively associated with mortality, with the inverse true for high intake of plant protein, especially among individuals with at least one (1) life style risk factor. Replacement of animal protein with plant protein was associated with lower mortality, suggesting the importance of protein source.

Though it is evident that plant-based diet and proteins provide more advantages than animal-based diet and proteins, most plant-based foods are incomplete sources of protein, meaning they don't contain all the sufficient amount of essential amino acids that human body needs but can't make. The only known plant-based protein that has a complete amino acid profile with high digestibility is soy. However, soy, one of eight major food allergens recognized by US Food and Drug Administration (US FDA), poses risks to these who are sensitive to soy protein. In addition, soy contains phytoestrogens called isoflavones that can affect the activity of natural estrogen in human body, causing unexpected discomfort.

One way to resolve incomplete amino acid profile of plant-based protein is to prepare a protein mix that can serve as a complete and well-balanced source of amino acids for human physiological requirements. The nine essential amino acids include histidine, isoleucine, leucine, lysine, methionine, phenylalanine, threonine, tryptophan and valine.

In order to evaluate the quality of a protein, US FDA and the Food and Agricultural Organization of the United Nations/World Health Organization (FAO/WHO) in 1993 adopted Protein Digestibility-Corrected Amino Acid Score (PDCAAS) is a method based on both the amino acid requirements of humans and their ability to digest the protein. Since then, the PDCAAS score has been recognized as the preferred method to determine protein quality. Foods are evaluated on a scale of 0 to 1 with 1 being the highest. While compositions can have protein qualities higher than 1.00 standard practice is to truncate the score to 1.00.

PDCAAS is calculated as: PDCAAS=(mg of limiting amino acid in 1 g of test protein/mg of same amino acid in 1 g of reference protein) x fecal true digestibility percentage.

Here, the reference protein essential amino acid profile was the amino acid requirement pattern for the 2-5-year-old child as shown in Table 1.

TABLE 1
Essential Amino Acid Profile of Reference
Protein for PDCAAS determination

| Essential Amino Acid | mg/g of Protein |
|---|---|
| Histidine | 19 |
| Isoleucine | 28 |
| Leucine | 66 |
| Lysine | 58 |
| Methionine + Cystine | 25 |
| Phenylalanine + | 63 |
| Tyrosine | |
| Threonine | 34 |
| Tryptophan | 11 |
| Valine | 35 |

Animal-based foods and proteins such as casein, whey and egg white score 1.00 on the PDCAAS scale while plant-based foods and proteins typically having lower scores. For example, vegetables have scores ranging between 0.7-0.89, fresh fruit between 0.64-0.76, legumes between 0.7-0.89. Table 2 lists the typical PDCAAS of selected foods showing different scores between animal-based and plant-based foods, also the differences between protein isolates, raw and cooked foods.

TABLE 2
PDCAAS
of Selected Foods

| Foods | PDCAAS |
|---|---|
| Casein and Whey | 1 |
| Egg white | 1 |
| Soy Protein Isolates | 1 |
| Beef | 0.92 |
| Soy Beans | 0.91 |
| Pea Protein | 0.89 |
| Concentrate | |
| Cooked Rice | 0.62 |
| Cooked Pea | 0.60 |
| Peanut | 0.52 |
| Rice | 0.47 |
| Rice Protein | 0.42 |
| Concentrate | |
| Corn | 0.42 |
| Wheat | 0.42 |
| Wheat Gluten | 0.25 |

There is a need at present for way to deliver a complete amino acid profile of plant-based proteins. Prior inventions have addressed portions of this need but have not addressed optimal characteristics as claimed in this invention.

Previous protein compositions lack complete amino acid profiles. Also, many prior compositions are completely animal-based compositions, rather than plant or vegetarian protein-based compositions. Furthermore, many prior compositions rely on soy for a main source of protein. Again, soy is the only known plant-based protein that has a complete amino acid profile with a high digestibility; however, soy is a major allergen. Prior art protein compositions containing mainly soy pose a problem for allergies; prior art protein compositions that are solely animal-based pose a problem for digestibility; prior art protein compositions lacking a complete amino acid profile pose a problem for incomplete nutrition. Thus, there is a need for the current invention of a nutritional composition of blended vegetarian proteins which addresses and solves all of these previous problems.

European Patent Specification No. 2880996 entitled “Nutritional Compositions Containing Brown Rice Protein” recommends the combination of brown rice protein, pea protein and soy protein to partially replace dairy protein in nutritional powder shakes and liquid beverages. While the disclosed invention partially replaces dairy protein, it does not provide a complete amino acid profile in the form of a highly digestible vegetarian protein.

U.S. Patent Application Publication No. 2008/0206430 entitled “Compositions Consisting of Blended Vegetarian Proteins” describes the combination of soy protein, rice protein and pea protein to impart a digestibility comparable to whey. It discloses a vegetarian nutritional supplement including soy protein, rice protein and pea protein which are blended in particular rations, by weight, to impart a level of digestibility comparable to whey, which is the benchmark for non-vegetarian foot products and nutritional supplements. While the invention discloses compositions consisting of blended vegetarian proteins, it does not provide a complete amino acid profile in the form of a highly digestible vegetarian protein.

U.S. Patent Application Publication No. 2009/0208633 entitled “Protein Composition for Meat Products or Meat Analog Products” described the use of soy protein and wheat protein in meat and meat analog products. The invention relates to a protein composition and to the use of the protein composition in meat products, vegetable products, and fruit products. This invention also relates to a process for preparing the protein composition. Further, this invention relets to a meat product containing the protein composition and the process for making the same by the combination of the protein composition, a meat source, and water, such that meat product is obtained having a texture similar to that of intact muscles. While the invention discloses protein compositions for vegetable products, it does not provide a complete amino acid profile in the form of a highly digestible vegetarian protein.

U.S. Patent application Publication No. 2009/0221502 entitled “Vegetarian Anabolic Protein Composition” recommends using soy protein, rice protein and pea protein in combination with amino acids lysine and glycine to closely match the amino acid profile of human muscle tissue. The invention discloses that vegetarian amino acid sources are combined to create a protein blend that closely matches human muscle tissues in term of amino acid composition, meaning that the amino acid composition of the protein blend is within five percent of the amino acid composition of human muscle for all of the amino acids of the human muscle. The protein blend can be used as food or food supplement to facilitator and bolster muscle anabolism for healthy humans desiring such results and also to treat and or ameliorate the effects of certain diseases and conditions such as sarcopenia, cancer cachexia, HIV wasting, malnutrition, primary muscle disease (myopathy) and side effects of corticosteroid therapy. While the invention discloses a vegetarian anabolic protein composition, it does not provide a complete amino acid profile in the form of a highly digestible vegetarian protein.

U.S. Patent Application Publication No. 2011/0144006 entitled “Protein Composition” creates a blend of potato protein, pea protein and soy protein for the application of nutritional supplements. The invention relates to a protein composition which upon ingestion by a healthy person with a normal fasting insulin level between 3.0-8.0 mIU/L increase the insulin level to at most 20.0 mIU/L. The invention may be in the shape of a powder, capsules, pellets, tablets, effervescent tablets or food products comprising said protein composition. While the invention discloses a vegetarian anabolic protein composition, it does not provide a complete amino acid profile in the form of a highly digestible vegetarian protein.

U.S. Patent Application Publication No. 2012/0128832 entitled “Organic Vegan Protein Shakes” presents a sports shake and drink formulation consisting of organic hemp protein and pea protein in combination of soy milk and almond milk as additional protein sources. The present invention relates to Organic Vegan Proteins sports drinks and shakes formulated from 100% organic and natural plant-based ingredients with the highest grade of protein, vitamins, minerals and other nutrients. The Organic plan proteins used in the drinks and shakes are predominately, Organic Hemp Powder, Organic Pea Powder and Organic Vegan powder (made from a mixture of Organic seed sprouts. Organic Soy milk and Organic Almond mild provide additional sources of proteins in the shakes. The shakes are packaged in ready to drink tetra pack containers. While the invention discloses Organic Vegan Protein Shakes, these shakes do not provide a complete amino acid profile in the form of a highly digestible vegetarian protein.

U.S. Patent Application Publication No. 2017/0042209 entitled “Composition Comprising Sacha Inchi Protein in Combination with other Plant Proteins” presents a protein mix of sacha inchi protein, pea protein, rice protein and potato protein with a high digestibility. The invention is directed to a high-quality plant-based non-soy protein blend. In particular it provides a composition for use as meal replacement comprising administering to a subject a composition comprising Sacha inchi protein, pea protein, rice protein and potato protein in an amount effective to maintain promote satiety, healthy body weight and lean muscle mass. While the invention discloses a protein composition, its does not provide a complete amino acid profile in the form of a highly digestible vegetarian protein.

The prior art thus exhibits several disadvantages that are addressed by the present invention. The present invention incorporates a novel composition that includes a complete amino acid profile in blended vegetarian proteins. The novel composition exhibits an optimal level of digestibility from vegetarian proteins comparable to animal-based proteins.

### SUMMARY OF THE INVENTION

The invention relates to a hypoallergenic plant-based protein blend with a complete amino acid profile comparing to FAO/WHO requirements to 2-5-year-old preschool children. Specifically, the combination of fava, mung bean, pea and rice proteins complement each other in terms of amino acid profile.

As described previously, PDCAAS is determined by the value of limiting essential amino acid (EAA), adjusting the ratios of these protein may lead the value of limiting EAA of the blend exceed the FAO/WHO requirements for 2-5-year-old preschool children, thereby increasing PDCAAS as indicated in the equation. In certain situations, by combining these proteins and adjusting the ratio, it is possible to generate a blend that has a PDCAAS of 1.0.

In addition, the ratios of these protein are also determined by taste, flavor, texture, mouth feel and after taste, for example, fava, pea and mung bean have less after taste than rice protein. In practice, rice protein percentage is minimized in the blend to achieve a more favorable finished product. The essential amino acid contents of the different protein components of the blend are set out in Table 3 below.

TABLE 3
Amino Acid Profile of Fava Protein, Mung Bean Protein, Pea
Protein and Rice Protein

| | | Mung Bean | Pea | Rice |
|---|---|---|---|---|
| | Fava Protein | Protein | Protein | Protein |
| | (mg/g | (mg/g | (mg/g | (mg/g |
| | protein) | protein) | protein) | protein) |
| Histidine | 29 | 31 | 27 | 29 |
| Isoleucine | 54 | 50 | 53 | 54 |
| Leucine | 99 | 104 | 96 | 101 |
| Lysine | 76 | 73 | 84 | 41 |
| Methionine + Cystine | 20 | 71 | 20 | 64 |
| Phenylalanine + | 98 | 104 | 112 | 151 |
| Tyrosine | | | | |
| Threonine | 41 | 35 | 39 | 43 |
| Tryptophan | 13 | 8 | 8 | 16 |
| Valine | 60 | 47 | 55 | 75 |

Rice protein is low in Lysine while fava, mung bean and pea proteins lack of sulfur-containing amino acids (methionine+cystine), which makes either a complete protein. On the other side, mung bean and pea protein are low in tryptophan too. Table 4 shows the examples of adjusting the protein ratios to achieve the protein blends that contains a complete amino acid profile and a PDCAAS of 1.0.

A nutritional composition of fava, mung bean, pea and rice proteins consist of 0-95% fava protein, 0-75% rice protein, 0-75% mung bean and 0-75% pea protein.

Preferably, a nutritional composition of fava, mung bean, pea and rice proteins consist of 0-90% fava protein, 0-40% rice protein, 0-60% mung bean and 0-60% pea protein.

Preferably, a nutritional composition of fava, mung bean, pea and rice proteins consist of 30-50% fava protein, 10-20% rice protein, 10-20% mung bean and 10-20% pea protein.

TABLE 4
Examples of Combinations of Different Protein Ratios

| | Example | Example | Example | Example | Example |
|---|---|---|---|---|---|
| | 1 | 2 | 3 | 4 | 5 |
| Fava Protein | 88.0% | 60.0% | 40.0% | 0.0% | 0.0% |
| Mung Bean | 0.0% | 15.0% | 20.0% | 60.0% | 0.0% |
| Protein | | | | | |
| Pea Protein | 0.0% | 15.0% | 10.0% | 0.0% | 60.0% |
| Rice Protein | 12.0% | 10.0% | 30.0% | 40.0% | 40.0% |
| PDCAAS | 1.0 | 1.0 | 1.0 | 1.0 | 1.0 |

### DETAILED DESCRIPTION OF THE PREFERRED EMBODIMENT

The invention provides a hypoallergic protein composition wherein said proteins mainly are derived from allergen-free vegetable sources, being a complete protein source for human beings with a particularly high digestibility. The dietary or nutritional application of the present invention may be in the form of powdered drink mix, ready-to-drink liquids, nutrition gels, protein bars, tablets, soft gels, two-piece hard gelatin capsules, effervescent tablets, gummy chews or soft chews.

### EXAMPLE 1

### Powdered Protein Shake

If the protein composition is used as a nutritional powdered protein shake, additional components may be added to the protein composition to improve the nutritional value. Additional components include vitamins, minerals and fatty acids such as saturated, polyunsaturated or monosaturated fatty acids. Other components may be flavoring agents, coloring agents, texture modifiers as well as sweetening agents. Sweeteners include all state-to-art natural and artificial sweetening agents, but not limited to sucralose, acesulfame K, aspartame, monk fruit extract, stevia leaf extracts, glycyrrhizin, thaumatin, saccharin, naringin dihydrochalcone, neotame, sugar alcohols such as erythritol, mannitol, maltitol, sorbitol, xylitol and a mixture of two or more thereof. Texture modifiers includes emulsifiers such as lecithin and other phosphatidyl lipids and thickeners such as pectin, locus bean gum, guar gum, xanthan gum, gum acacia, gum arabica.

Further additives to a nutritional powdered protein shake are a fibers, prebiotics, probiotics and digestive enzymes. Fibers include water-soluble fibers such as beta-glucan, galactooligosaccharide, inulin, resistant maltodextrin, pectin, psyllium husk, polydextrose, hydroxypropylmethylcellulose and water-insoluble dietary fiber such as cellulose, resistant starch and other whole foods and vegetable fibers. Prebiotics are oligosaccharides that are service as the energy source for probiotics and promote the growth of probiotics. Examples of prebiotics are Fructooligosacchardies, Galactooligosaccharides, inulin and Xylooligosacchardics. Probiotics arc living microbial organisms that can enhance the microbial environments in human digestive tract and promote the digestive health. Examples of popular probiotics are Bifidobacterium such as the strains B. adolescentis, B. animalis, B. bifidum, B. longum, B. thermophilwn, Lactobacillus, such as the strains L. acidophilus, L. brevis, L. casei, L. bulgaricus, L. fermentum, L. GG, L. lactis, L. plantarum, L. reuteri, L. rhamnosus, L. salivarius, Bacillus cereus toyoi. Bacillus cereus, Bacillus coagulans, Streptococcus Such as the strains S. Cremoris, S. infantarius, S. intermedius, S. lactis.

In aid in digestive health and nutrient absorption, further additives to a nutritional powdered protein shakes are digestive enzymes such as amylase, lipase, protease, cellulase, alpha-galactosidase, amyloglucosidase, beta-glucanase, bromelain, dextranase, pepsin, hemicellulase, invertase, trypsin, pectinase, papain, peptidase, and xylanase.

A protein shake formula with a serving size of 50 g powder is shown in Table 5. This nutrition shake provides 20 g plant-based protein from a preferred hypoallergenic composition of fava, mung bean, pea and rice protein.

TABLE 5
Formula of Example 1

| | | | | Percentage |
|---|---|---|---|---|
| | | Ingredient | Protein | in |
| Function | Ingredient | quantity | Ratio | Formula |
| Protein | Fava protein | 11.70 g | 45.0% | 23.40% |
| | Mung bean protein | 3.90 g | 15.0% | 7.80% |
| | Pea protein | 6.50 g | 25.0% | 13.00% |
| | Rice protein | 3.90 g | 15.0% | 7.80% |
| | | | 100.0% | |
| Fat | Sunflower oil creamer | 5.00 g | | 10.00% |
| | Cellulose gum | 1.00 g | | 2.00% |
| Fibers | Galactooligosaccharides | 5.00 g | | 10.00% |
| | Fructose | 10.00 g | | 20.00% |
| Sweetener | Sucralose | 0.05 g | | 0.10% |
| Flavors | Vanilla flavor | 1.50 g | | 3.00% |
| Texture | Xanthan gum | 0.50 g | | 1.00% |
| Modifiers | | | | |
| Excipients | Maltodextrin | 0.70 g | | 1.40% |
| | Silicon Dioxide | 0.25 g | | 0.50% |
| Total | | 50.00 g | | 100.00% |

### EXAMPLE 2

### Protein Ready-To-Drink Liquid

The application of this invention also includes ready-to-drink liquids and concentrated liquids. These liquid compositions may include solutions, suspensions, and emulsions. The nutritional compositions may be formulated with sufficient kinds and amounts of nutrients, as described in Example 1, to provide a nutritional product with high digestibility.

A formula of a protein RTD liquid is shown in table 6, the formula provides 20 g protein per 12 oz in a liquid form. The formula includes a preferred composition of hypoallergenic plant-based blend of fava, mung bean, pea and rice protein.

TABLE 6
Formula of Example 2

| | | | | Percentage |
|---|---|---|---|---|
| | | Ingredient | Protein | in |
| Function | Ingredient | quantity | Ratio | Formula |
| Protein | Fava protein | 14.30 g | 55.0% | 3.81% |
| | Mung bean protein | 3.90 g | 15.0% | 1.04% |
| | Pea protein | 2.60 g | 10.0% | 0.69% |
| | Rice protein | 5.20 g | 20.0% | 1.39% |
| | | | 100.0% | |
| Fat | Sunflower oil | 5.00 g | | 1.33% |
| Fibers | Polydextrose | 5.00 g | | 1.33% |
| Prebiotics | Xylooligosaecharides | 1.00 g | | 0.27% |
| | Fructose | 10.00 g | | 2.67% |
| Sweetener | Stevia | 0.15 g | | 0.04% |
| Flavors | Vanilla flavor | 1.50 g | | 0.40% |
| Texture | Locus bean gum | 0.50 g | | 0.13% |
| Modifiers | Cellulose gum | 0.50 g | | 0.13% |
| Emulsifier | Lecithin | 0.20 g | | 0.05% |
| Excipients | Maltodextrin | 1.15 g | | 0.31% |
| | Water | 324.00 g | | 86.40% |
| Total | | 375.00 g | | 100.00% |

Those skilled in the art to which this application relates will appreciate that other and further additions, deletions, substitutions and modifications may be made to the described examples or embodiments.

What is claimed is:

1. A nutritional composition comprised of fava protein, mung bean protein, pea protein and rice protein.

2. The composition of claim 1 wherein the composition is plant-based suitable for vegetarian and vegan consumers.

3. The composition of claim 1 wherein the composition is free of major allergens that are recognized by US Food and Drug Administration.

4. The composition of claim 1 wherein the composition has a PDCAAS protein quality of 0.95 or greater.

5. The composition of claim 1 wherein the composition has a PDCAAS protein quality of 0.98 or greater.

6. The composition of claim 1 wherein the composition has a PDCAAS protein quality of 1.00.

7. The composition of claim 1 wherein the composition comprises 0-90% fava protein, 0-60% rice protein and 0-80% of combination of mung bean protein and pea protein.

8. The composition of claim 1 wherein the composition comprises 20-70% fava protein, 5-40% rice protein and 15-55% of combination of mung bean protein and pea protein.

9. The composition of claim 1 wherein the composition comprises 40-50% fava protein, 10-20% rice protein and 30-50% of combination of mung bean protein and pea protein.

10. The composition of claim 1 which is provided in a beverage, a non-beverage food, a liquid or a dietary supplement.

11. The composition of claim 10 wherein the beverage is a shake.

12. The composition of claim 10 wherein the non-beverage food is a protein bar.

13. The composition of claim 10 wherein the liquid is a Ready-to-Drink liquid.

14. The composition of claim 10 wherein the dietary supplement is a tablet, capsule, soft gel or gummy.
